(19) United States
(12) Patent Application Publication
(10) Pub. No.: US 2016/0161793 A1
(43) Pub. Date: Jun. 9, 2016

(54) DISPLAY DEVICE HAVING IMPROVED LIFTING CHARACTERISTICS

(71) Applicant: SAMSUNG DISPLAY CO., LTD., Yongin-si (KR)

(72) Inventors: Jun Heui LEE, Seoul (KR); Jae Cheol Park, Hwaseong-si (KR); Hee-Keun Lee, Suwon-si (KR); Gyeong Eun Eoh, Seoul (KR)

(21) Appl. No.: 14/958,732

(22) Filed: Dec. 3, 2015

(30) Foreign Application Priority Data
Dec. 4, 2014 (KR) 10-2014-0173324

(51) Int. Cl. G02F 1/1333; G02F 1/1341; G02F 1/1335

(52) U.S. Cl. CPC G02F 1/133345; G02F 1/133528; G02F 1/133514; G02F 1/1341; G02F 2001/133388

(57) ABSTRACT

A display device includes: a display part including a plurality of pixel areas formed on a substrate; and a non-display part positioned outside and proximate to the display part. The display part includes: a pixel electrode formed in at least one of the pixel areas; a roof layer formed on the pixel electrode so as to be spaced apart from the pixel electrode with a cavity interposed therebetween; a liquid crystal positioned within the cavity; an injection hole formed in the roof layer; and an overcoat formed on the roof layer so as to cover the injection hole and seal the cavity. The non-display part includes a step compensation part configured to compensate for a difference in elevation between an upper surface of the display part and an upper surface of the non-display part, the step compensation part including a material of the roof layer.

### CROSS-REFERENCE TO RELATED APPLICATION

This application claims priority to, and the benefit of, Korean Patent Application No. 10-2014-0173324 filed in the Korean Intellectual Property Office on Dec. 4, 2014, the entire contents of which are incorporated herein by reference.

### BACKGROUND

(a) Field

Embodiments of the present invention relate generally to flat panel display devices. More specifically, embodiments of the present invention relate to display devices having improved lifting characteristics.

(b) Description of the Related Art

A liquid crystal display device, which is a widely used type of flat panel display device, includes two display panels on which electric field generating electrodes such as a pixel electrode, a common electrode, and the like, are formed. A liquid crystal layer is interposed between the two display panels, and generates an electric field in the liquid crystal layer by applying a voltage to the electric field generating electrode, thereby determining alignment of liquid crystal molecules of the liquid crystal layer and controlling polarization of incident light, thus displaying an image.

The two display panels of the liquid crystal display device may be a thin film transistor display panel and a counter display panel. Gate lines transmitting gate signals and data lines transmitting data signals may be formed on the thin film transistor display panel so as to intersect with each other, and thin film transistors connected to the gate lines and the data lines, pixel electrodes connected to the thin film transistors, and the like may be formed on the thin film transistor display panel. A light blocking member, a color filter, a common electrode, and the like may be formed on the counter display panel. In some cases, the light blocking member, the color filter, the common electrode, and the like may also be formed on the thin film transistor display panel.

However, in conventional liquid crystal display panels, two substrates are necessarily used, and the respective components are formed on the two substrates. Therefore, the liquid crystal display device is heavy and thick, manufacturing the liquid crystal display device entails significant expense, and requires a long process time.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a display device and a manufacturing method therefor having advantages of decreased weight, thickness, cost, and process time by manufacturing the display device using a single substrate.

Further, embodiments of the present invention provide a display device having a flatter overcoat due to reduction in height difference between a display part and its adjacent non-display part.

An exemplary embodiment of the present invention provides a display device including: a display part including a plurality of pixel areas formed on a substrate; and a non-display part positioned outside and proximate to the display part. The display part includes: a pixel electrode formed in at least one of the pixel areas; a roof layer formed on the pixel electrode so as to be spaced apart from the pixel electrode with a cavity interposed therebetween; a liquid crystal positioned within the cavity; an injection hole formed in the roof layer; and an overcoat formed on the roof layer so as to cover the injection hole and seal the cavity. The non-display part includes a step compensation part configured to compensate for a difference in elevation between an upper surface of the display part and an upper surface of the non-display part, the step compensation part including a material of the roof layer.

The step compensation part may further include one or more materials of the display part.

The display part may have a common electrode formed therein so as to be electrically insulated from the pixel electrode.

The display device may further include a color filter stacked below the pixel electrode.

The roof layer may be formed so as to cover the display part and to extend into the non-display part.

The cavity may be formed by applying a sacrifice layer onto the pixel electrode, patterning the sacrifice layer, forming the roof layer on the sacrifice layer, and removing the sacrifice layer.

The step compensation part may include at least one color filter layer.

The step compensation part may include material of the sacrifice layer.

The color filter and the pixel electrode may have a first insulating layer formed therebetween.

The step compensation part may include the first insulating layer.

The step compensation part may have a width of approximately 0.01 to 5 μm.

The step compensation part may have a height of approximately 1 to 30 μm.

The step compensation part may be formed so as to substantially surround four outer edges of the display part.

The step compensation part may be formed so as to be proximate to less than every outer edge of the display part.

The display device may further include a polarizer attached to the overcoat.

The polarizer may be substantially entirely attached to an upper portion of the step compensation part.

The display device and the manufacturing method therefor according to an exemplary embodiment of the present invention as described above have the following effects.

With the display device and the manufacturing method therefor according to an exemplary embodiment of the present invention, the display device is manufactured using a single substrate, thereby making it possible to decrease weight, thickness, cost, and process time of the display device.

In addition, in the display device according to an exemplary embodiment of the present invention, some of the materials configuring the display part are stacked outside the display part to form a step compensation part, thereby reducing unevenness of the overcoat caused by a step difference in height between the display part and the non-display part.

### BRIEF DESCRIPTION OF THE DRAWINGS

FIG. 1 is a plan view of a display device according to an exemplary embodiment of the present invention.

FIG. 2 is a schematic cross-sectional view of the display device taken along line II-II of FIG. 1.

FIG. 3 is a plan view showing one pixel of the display device according to an exemplary embodiment of the present invention.

FIG. 4 is a partial cross-sectional view of the display device according to an exemplary embodiment of the present invention taken along line IV-IV of FIG. 1.

FIG. 5 is a partial cross-sectional view of the display device according to an exemplary embodiment of the present invention taken along line V-V of FIG. 1.

FIG. 6 is a view showing a cross section of a display device according to a Comparative Example of the present invention that is substantially the same as a cross section of FIG. 2.

FIGS. 7 to 10 are views showing materials configuring a step compensation part according to another exemplary embodiment of the present invention.

FIG. 11 is a graph showing a thickness of an overcoat in the display device according to a Comparative Example.

FIG. 12 is an image of a polarizer attached to an overcoat of the display device according to a Comparative Example.

FIGS. 13A to 13 D are graphs obtained by simulating an overcoat planarization effect by compensation of a lower step.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. The various Figures are thus not to scale. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. All numerical values are approximate, and may vary. All examples of specific materials and compositions are to be taken as nonlimiting and exemplary only. Other suitable materials and compositions may be used instead.

Hereinafter, a display device according to an exemplary embodiment of the present invention will be schematically described below.

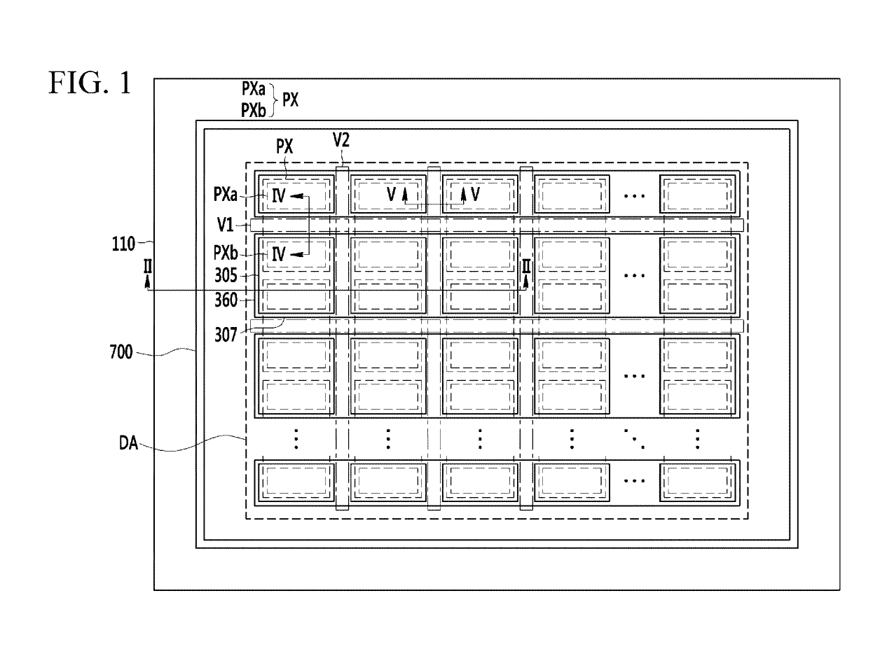

FIG. 1 is a plan view of a display device according to an exemplary embodiment of the present invention. For convenience, only some components are shown in FIG. 1.

The display device according to an exemplary embodiment of the present invention includes a substrate 110 made of a material such as glass, plastic, or the like, and a roof layer 360 formed on the substrate 110.

The substrate 110 includes a plurality of pixel areas PX. The pixel areas PX are disposed in a matrix form including a plurality of pixel rows and a plurality of pixel columns. Each pixel area PX may include a first sub-pixel area PXa and a second sub-pixel area PXb. The first sub-pixel area PXa and the second sub-pixel area PXb may be disposed at upper and lower portions of their pixel PX. That is, the sub-pixels PXa and PXb may be arranged in a vertical column.

A first valley V1 is positioned in a pixel row direction between the first sub-pixel area PXa and the second sub-pixel area PXb, and a second valley V2 is positioned between adjacent pixel columns.

The roof layer 360 is formed in the pixel row direction. Here, the roof layer 360 is removed in the first valley V1, such that an injection hole 307 is formed, and components positioned below the roof layer 360 may be thereby exposed to the outside.

The respective roof layers 360 are formed so as to be spaced apart from the substrate 110 between adjacent second valleys V2, such that a microcavity 305 is formed. In addition, the respective roof layers 360 are formed so as to be attached to the substrate 110 in the second valleys V2, thereby covering both sides of the microcavity 305.

Although the roof layer 360 is shown in FIG. 1 as being formed in the display area DA, the roof layer 360 actually extends beyond and outside of the display area DA in an exemplary embodiment of the present invention. For example, the roof layer 360 may be extended out to a step compensation part 700. In addition, although not shown in FIG. 1, an overcoat formed on the roof layer may also be extended up to the area of the step compensation part.

Referring to FIG. 1, the display device according to an exemplary embodiment of the present invention may include the step compensation part 700 formed along an outer edge of the display area DA.

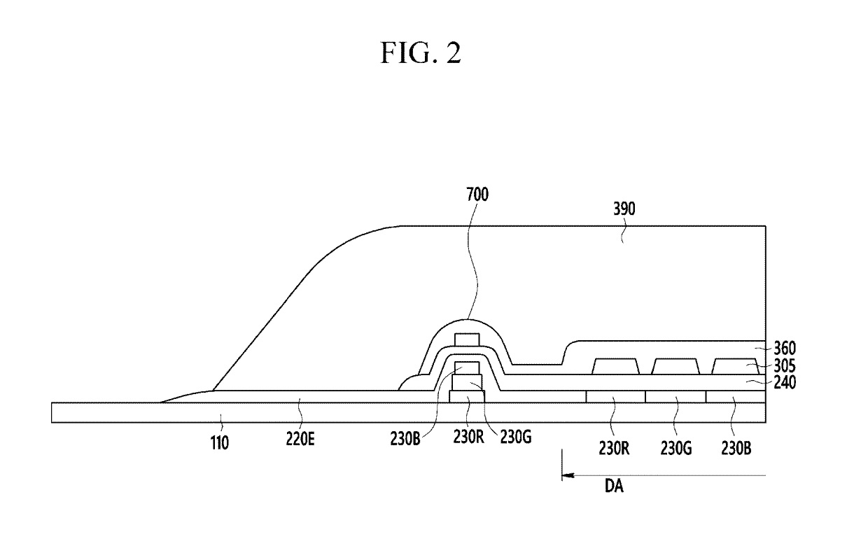

FIG. 2 is a schematic cross-sectional view of the display device taken along line II-II of FIG. 1. Referring to FIG. 2, the step compensation part 700 of the display device according to an exemplary embodiment of the present invention may be made of some of the same materials as those used for pixel Px. That is, as described below, one or more of a color filter 230, a first insulating layer 240, a sacrifice layer 300, and the roof layer 360 configuring the pixel Px may be stacked to form the step compensation part 700.

The step compensation part 700 compensates for a step difference in height or elevation between the display area DA and its neighboring non-display area, to allow the overcoat 390 to be flatly formed, or formed with a flatter upper surface. In the case in which the step compensation part 700 is not present, a groove is formed at an edge of the overcoat 390 due to a step change in height at the edge of the display area DA, and due to surface tension of a material of the overcoat 390. This groove subsequently causes a problem that a polarizer or the like may not be uniformly attached, which hinders a bezel from being minimized.

However, in the display device according to an exemplary embodiment of the present invention, the step compensation part 700 compensating for the step is formed at the outer side of the display part DA to allow an upper portion of the overcoat 390 to be more flatly formed. Further details are described below.

Although the step compensation part 700 is shaped to enclose the four edges of the display part (DA) in FIG. 1, the step compensation parts 700 may alternatively be formed as four bars separated from each other and positioned on the four edges of the display part, respectively. In addition, the step compensation parts 700 may also be formed at only some of the four edges of the display part DA.

In addition, the structure of the display device according to this exemplary embodiment of the present invention is only an example, and may be modified in various ways. For example, the shapes and configurations of the pixel area PX, the first valley V1, and the second valley V2 may be changed, the plurality of roof layers 360 may also be connected to each other in the first valley V1, and some of the respective roof layers 360 may also be formed so as to be spaced apart from the substrate 110 in the second valley V2, such that adjacent microcavities 305 may be connected to each other.

Next, one pixel of the display device according to an exemplary embodiment of the present invention will be described with reference to FIGS. 1 to 5.

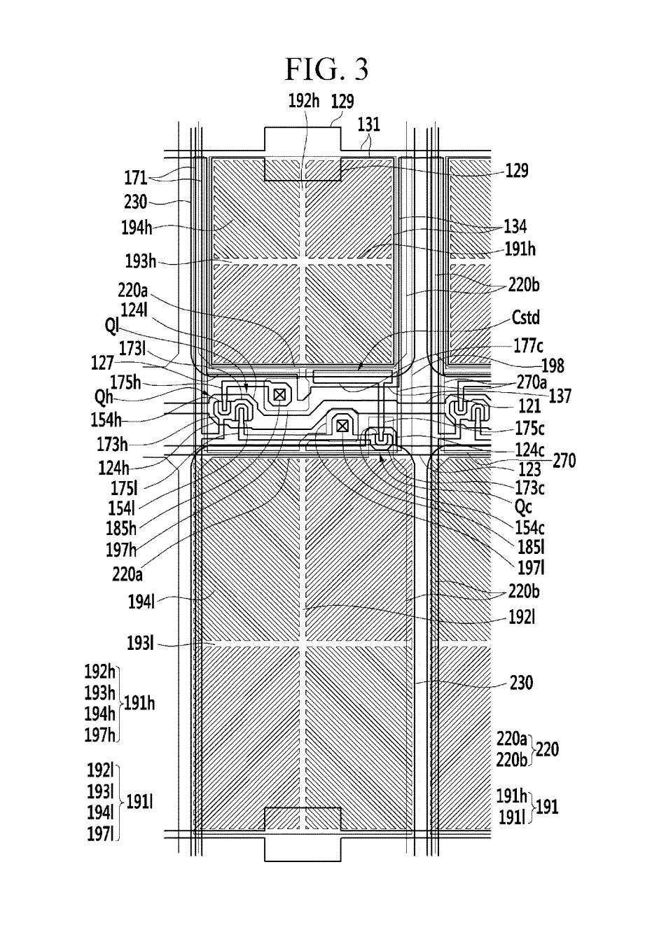

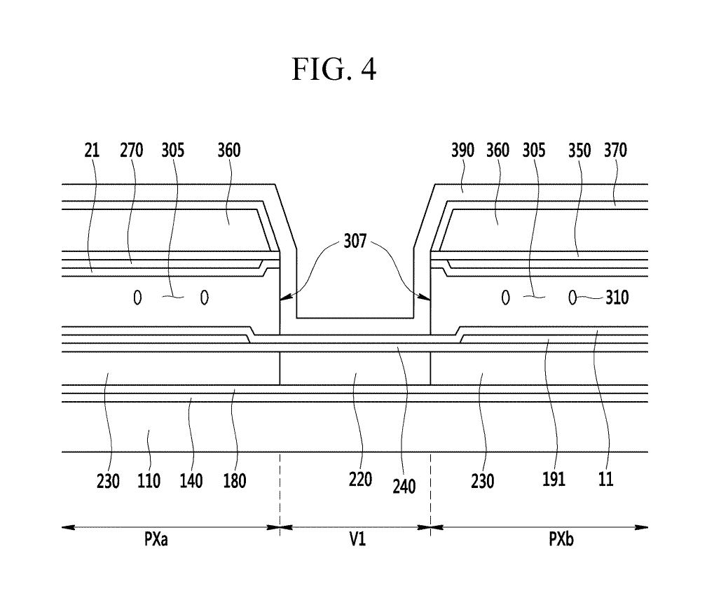

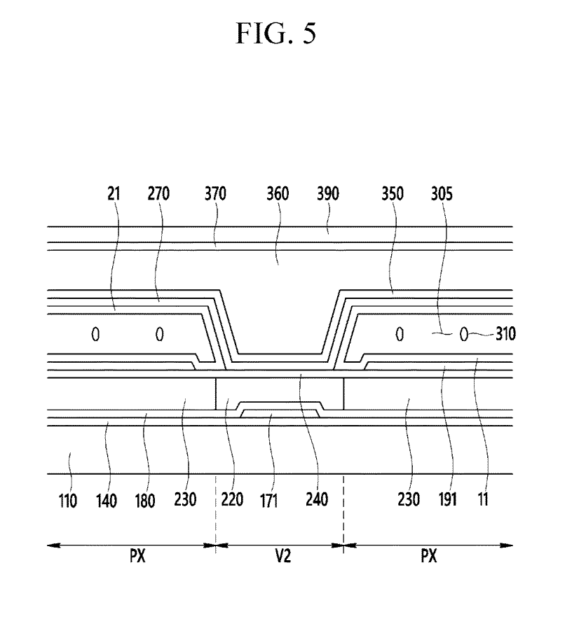

FIG. 3 is a plan view showing one pixel of the display device according to an exemplary embodiment of the present invention; FIG. 4 is a partial cross-sectional view taken along line IV-IV of FIG. 1; and FIG. 5 is a partial cross-sectional view of the display device taken along line V-V of FIG. 1.

Referring to FIGS. 1 to 5, a plurality of gate conductors including a plurality of gate lines 121, a plurality of step-down gate lines 123, and a plurality of sustain electrode lines 131 are formed on the substrate 110.

The gate lines 121 and the step-down gate lines 123 mainly extend in a horizontal direction, and transfer gate signals. The gate conductors further include first and second gate electrodes 124h and 124l protruding both upward and downward from the gate line 121 and a third gate electrode 124c protruding upward from the step-down gate line 123. The first and second gate electrodes 124h and 124l are connected to each other to form one protrusion part. Here, the first, second, and third gate electrodes 124h, 124l, and 124c and their protrusions may take on various shapes as desired.

The sustain electrode lines 131 mainly extend in the horizontal direction and transfer a predetermined voltage, such as a common voltage Vcom or the like. The sustain electrode line 131 includes sustain electrodes 129 protruding upward and downward from the line 131, a pair of vertical parts 134 extended downward so as to be substantially perpendicular to the gate line 121, and a horizontal part 127 connecting ends of the pair of vertical parts 134 to each other. The horizontal part 127 includes a capacitor electrode 137 extended downward.

A gate insulating layer 140 is formed on the gate conductors 121, 123, 124h, 124l, 124c, and 131. The gate insulating layer 140 may be made of an inorganic insulating material such as a silicon nitride (SiNx), a silicon oxide (SiOx), or the like. In addition, the gate insulating layer 140 may be formed as a single layer or a multilayer.

A first semiconductor 154h, a second semiconductor 154l, and a third semiconductor 154c are formed on the gate insulating layer 140. The first semiconductor 154h may be positioned on the first gate electrode 124h, the second semiconductor 154l may be positioned on the second gate electrode 124l, and the third semiconductor 154c may be positioned on the third gate electrode 124c. The first semiconductor 154h and the second semiconductor 154l may be connected to each other, and the second semiconductor 154l and the third semiconductor 154c may also be connected to each other. In addition, the first semiconductor 154h may also extend below a data line 171. The first to third semiconductors 154h, 154l, and 154c may be made of an amorphous silicon, a polycrystalline silicon, a metal oxide, or the like.

Ohmic contacts (not shown) may be further formed on the first to third semiconductor 154h, 154l, and 154c, respectively. The ohmic contacts may be made of a material such as a silicide or an n+ hydrogenated amorphous silicon doped with n− type impurities at a high concentration.

Data conductors including the data lines 171, first source electrodes 173h, second source electrodes 173l, third source electrodes 173c, first drain electrodes 175h, second drain electrodes 175l, and third drain electrodes 175c are formed on the first to third semiconductor 154h, 154l, and 154c.

The data lines 171 transfer data signals and mainly extend in the vertical direction to intersect with the gate lines 121 and the step-down gate lines 123. The respective data lines 171 also have extensions toward the first gate electrode 124 and the second gate electrode 124l, which form the connected first and second source electrodes 173h and 173l.

The first to third drain electrodes 175h, 175l, and 175c each include one end portion that is wide and another end portion that has a rod shape. The rod-shaped end portions of the first and second drain electrodes 175h and 175l are partially enclosed by the first and second source electrodes 173h and 173l. The widened end portion of the second drain electrode 175l has a “U” shape to form the third source electrode 173c. The wide end 177c of the third drain electrode 175c overlaps the capacitor electrode 137 to form a step-down capacitor Cstd, and the rod-shaped end of third drain electrode 175c is partially enclosed by the third source electrode 173c.

The first gate electrode 124h, the first source electrode 173h, and the first drain electrode 175h form, together with a first semiconductor 154h, a first thin film transistor Qh. Similarly, the second gate electrode 124l, the second source electrode 173l, and the second drain electrode 175l form, together with a second semiconductor 154l, a second thin film transistor Ql. Likewise, the third gate electrode 124c, the third source electrode 173c, and the third drain electrode 175c form, together with a third semiconductor 154c, a third thin film transistor Qc.

The first semiconductor 154h, the second semiconductor 154l, and the third semiconductor 154c may be connected to each other to thereby form a linearly shaped semiconductor structure, and may have plan-view shapes that are substantially the same as those of the data conductors 171, 173h, 173l, 173c, 175h, 175l, and 175c and the ohmic contacts disposed therebelow except for channel areas between the source electrodes 173h, 173l, and 173c and the respective drain electrodes 175h, 175l, and 175c.

The first semiconductor 154h has a portion exposed without being covered by the first source electrode 173h and the first drain electrode 175h (e.g., between the first source electrode 173h and the first drain electrode 175h), the second semiconductor 154l has a portion exposed without being covered by the second source electrode 173l and the second drain electrode 175l (e.g., between the second source electrode 173l and the second drain electrode 175l), and the third semiconductor 154c has a portion exposed without being covered by the third source electrode 173c and the third drain electrode 175lc (e.g., between the third source electrode 173c and the third drain electrode 175lc).

A passivation layer 180 is formed on the semiconductors 154h, 154l, and 154c and the data conductors 171, 173h, 173l, 173c, 175h, 175l, and 175c. The passivation layer 180 may be made of an organic insulating material or an inorganic insulating material, and be formed in a single layer or a multilayer configuration.

The color filters 230 are formed in the respective pixel areas PX on the passivation layer 180. Each color filter 230 may display one of the primary colors such as red, green, or blue. The color filter 230 is not limited to displaying these three primary colors, but may also (or instead) display a cyan, a magenta, a yellow, a white, or the like. The color filters 230 may have longer edges that extend along a column direction between neighboring data lines 171, or the longer edges may instead extend in a row direction.

Here, referring to FIGS. 1 and 2, the color filter 230 may be formed at the step compensation part 700 at an outer edge of the display area, as well as (or alternatively) within one pixel of the display area DA. At the step compensation part 700, all of the color filters 230 including a red 230R, a green 230G, and a blue 230B may be stacked, or one or two of the color filters 230 may be selectively stacked. Since depths of formed grooves are different from each other depending on a kind and a drying condition of overcoats 390, the number of color filters stacked in the step compensation part 700 may be appropriately adjusted depending on the materials used for the overcoats 390.

Light blocking members 220 are formed in areas between neighboring color filters 230. The light blocking members 220 may be formed at boundary portions of the pixel areas PX and over thin film transistors, to prevent leakage of light. The color filters 230 may be formed in the first and second sub-pixel areas PXa and Pxb, respectively, and the light blocking members 220 may be formed between the first and second sub-pixel areas PXa and Pxb.

The light blocking members 220 include horizontal light blocking members 220a extending along and over the gate lines 121 and the step-down gate lines 123, and covering an area in which the first thin film transistor Qh, the second thin film transistor Ql, the third thin film transistor Qc and the like are positioned. The light blocking members 220 also include and vertical light blocking members 220b extending along and over the data lines 171. That is, the horizontal light blocking members 220a may be formed in the first valley V1, and the vertical light blocking members 220b may be formed in the second valley V2. The color filters 230 and the light blocking members 220 may partially overlap each other.

As shown in FIG. 2, the light blocking member 220 may also have portions positioned outside the display area DA. This portion is shown in FIG. 2 as an outer light blocking member 220E. The outer light blocking member 220E may be formed by the same process as that for forming the light blocking member 220 in the display area, or may be formed by a separate process. In the case in which a stacked structure having multiple color filters 230 stacked upon each other is formed outside the display area DA, the outer light blocking member 220E may be formed to cover this stack structure.

The first insulating layer 240 may be further formed on the color filters 230 and the light blocking members 220. The first insulating layer 240 may be made of an inorganic insulating material such as a silicon nitride (SiNx), a silicon oxide (SiOx), a silicon oxynitride (SiOxNy), or the like. The first insulating layer 240 may serve to protect the color filters 230 and the light blocking members 220 (especially when they are made of an organic material) and may be omitted, if necessary.

The first insulating layer 240 also acts as a planarizing layer simultaneously with protecting the color filters 230 and the light blocking members 220. That is, the first insulating layer 240 helps create a flat surface for pixel electrode to be formed thereon.

The first insulating layer 240 may be extended outside the display area DA, as shown in FIG. 2. The first insulating layer 240 may be formed so as to cover the entirety of the substrate 110, although alternative embodiments entail only partial coverage.

A plurality of first contact holes 185h and a plurality of second contact holes 185l each exposing wide end portions of the first and second drain electrodes 175h and 175l are formed in the first insulating layer 240, the light blocking members 220, and the passivation layer 180.

The pixel electrode 191 is formed on the first insulating layer 240. The pixel electrode 191 may be made of a transparent metal material such as an indium tin oxide (ITO), an indium zinc oxide (IZO), or the like.

The pixel electrode 191 includes a first sub-pixel electrode 191h and a second sub-pixel electrode 191l separated from each other with the gate line 121 and the step-down gate line 123 interposed therebetween. The sub-pixel electrodes 191h and 191l are disposed at upper and lower portions of the pixel area PX, i.e. above and below the gate line 121 and the step-down gate line 123, and neighboring each other in the column direction. That is, the first sub-pixel electrode 191h and the second sub-pixel electrode 191l are separated from each other with the first valley V1 interposed therebetween, the first sub-pixel electrode 191h is positioned in the first sub-pixel area PXa, and the second sub-pixel electrode 191l is positioned in the second sub-pixel area PXb.

The first sub-pixel electrode 191h and the second sub-pixel electrode 191l are connected to the first drain electrode 175h and the second drain electrode 175l through the first contact hole 185h and the second contact hole 185l, respectively. Therefore, when the first thin film transistor Qh and the second thin film transistor Ql are in their on states, they receive data voltages from the first and second drain electrodes 175h and 175l.

Each of the first sub-pixel electrode 191h and the second sub-pixel electrode 191l generally has a rectangular shape and includes cross shaped stem parts including horizontal stem parts 193h and 193l and vertical stem parts 192h and 192l that intersect the horizontal stem parts 193h and 193l. In addition, the first sub-pixel electrode 191h and the second sub-pixel electrode 191l include a plurality of fine branch parts 194h and 1941 and protrusion parts 197h and 197l protruding upward or downward from edges or sides of the sub-pixel electrodes 191h and 191l, respectively.

The pixel electrode 191 is divided into four sub-areas by the horizontal stem parts 193h and 193l and the vertical stem parts 192h and 192l. The fine branch parts 194h and 1941 extend obliquely from the horizontal stem parts 193h and 193l and the vertical stem parts 192h and 192l, and a direction of extension of the fine branch parts 194h and 1941 may form an angle of approximately 45 degrees or 135 degrees with respect to the gate lines 121 or the horizontal stem parts 193h and 193l. In addition, directions of extension of the fine branch parts 194h and 1941 of two neighboring sub-areas may be perpendicular to each other.

In the present exemplary embodiment, the first sub-pixel electrode 191h further includes an outer stem part enclosing an outer side, and the second sub-pixel electrode 191l further includes horizontal parts positioned at upper and lower ends and left and right vertical parts 198 of the first sub-pixel electrode 191h. The left and right vertical parts 198 may prevent capacitive coupling between the data line 171 and the first sub-pixel electrode 191h.

The form in which the pixel area is disposed, the structure of the thin film transistor, and the shape of the pixel electrode described above are only examples. That is, the present invention is not limited thereto, but may be modified in various ways.

A common electrode 270 is formed above the pixel electrode 191 so as to be spaced apart from the pixel electrode by a predetermined distance. A microcavity 305 is formed between the pixel electrode 191 and the common electrode 270. That is, the microcavity 305 is enclosed by the pixel electrode 191 and the common electrode 270. A width of the microcavity 305 may be changed in any manner depending on, for example, a size and a resolution of the display device.

The common electrode 270 may be made of a transparent metal material such as an indium tin oxide (ITO), an indium zinc oxide (IZO), or the like. A predetermined voltage may be applied to the common electrode 270, and an electric field may be formed between the pixel electrode 191 and the common electrode 270.

A first alignment layer 11 is formed on the pixel electrode 191. The first alignment layer 11 may alternatively be formed only on that portion of the first insulating layer 240 which is not covered by the pixel electrode 191.

A second alignment layer 21 is formed beneath the common electrode 270 so as to face the first alignment layer 11.

The first alignment layer 11 and the second alignment layer 21 may be vertical alignment layers and may be made of an alignment material such as polyamic acid, polysiloxane, polyimide, or the like. The first and second alignment layers 11 and 21 may be connected to each other at an edge of the pixel area PX.

A liquid crystal layer made of liquid crystal molecules 310 is formed in the microcavity 305 so as to be positioned between the pixel electrode 191 and the common electrode 270. The liquid crystal molecules 310 may have negative dielectric anisotropy and may thus orient themselves in a direction perpendicular to the substrate 110 when no electric field is applied. That is, vertical alignment may be made.

The first sub-pixel electrode 191h and the second sub-pixel electrode 191l receive the data voltage to generate the electric field together with the common electrode 270, thus determining directions of the liquid crystal molecules 310 positioned within the microcavity 305 between the two elements 191 and 270. Luminance of light passing through the liquid crystal layer is altered depending on the direction of the liquid crystal molecules 310.

A second insulating layer 350 may be further formed on the common electrode 270. The second insulating layer 350 may be made of an inorganic insulating material such as a silicon nitride (SiNx), a silicon oxide (SiOx), a silicon oxynitride (SiOxNy), or the like, and be omitted if desired.

The roof layers 360 are formed on the second insulating layer 350. The roof layer 360 may be made of an organic material. The microcavity 305 is formed below the roof layer 360, and the roof layer 360 may be hardened by a hardening process to help maintain the shape of the microcavity 305. That is, with reference to FIG. 5, the thicker portions of roof layer 360 are formed so as to be spaced apart from each other with the pixel electrode 191 and the microcavity 305 interposed therebetween.

The thicker portions of roof layer 360 are formed in the respective pixel areas PX and the second valleys V2 along the pixel rows but are not formed in the first valleys V1. That is, as shown in FIG. 4, the thicker portions of roof layer 360 are not formed between the first sub-pixel area PXa and the second sub-pixel area PXb. The microcavities 305 are formed below the roof layer 360 in the first sub-pixel area PXa and the second sub-pixel area PXb. The microcavity 305 is not formed below the roof layer 360 in the second valley V2, and the roof layer 360 is formed so as to be attached to the substrate 110. Therefore, a thickness of the roof layer 360 positioned in the second valley V2 may be thicker than that of the roof layer 360 positioned in each first sub-pixel area PXa and second sub-pixel area PXb. Each microcavity 305 has a form in which an upper surface and both side surfaces thereof are covered by the roof layer 360.

As shown in FIG. 2, the roof layer 350 may also be formed outside the display area DA. In the case in which the roof layer 350 is expanded to the outside of the display area DA, it may configure a portion of the step compensation part 700.

The injection holes 307 exposing portions of the microcavities 305 are formed in the common electrodes 270, the second insulating layers 350, and the roof layers 360. The injection holes 307 may be formed at edges of the first sub-pixel area PXa and the second sub-pixel area PXb so as to face each other. That is, the injection holes 307 may be formed so as to expose side surfaces of the microcavities 305 that correspond to lower sides of the first sub-pixel area PXa and upper sides of the second sub-pixel area PXb. Since the interiors of microcavities 305 are exposed by the injection holes 307, an alignment agent, a liquid crystal material, or the like, may be injected into the microcavities 305 through the injection holes 307.

A third insulating layer 370 may be further formed on the roof layer 360. The third insulating layer 370 may be made of an inorganic insulating material such as a silicon nitride (SiNx), a silicon oxide (SiOx), a silicon oxynitride (SiOxNy), or the like. The third insulating layer 370 may be formed so as to cover an upper surface and side surfaces of the roof layer 360. The third insulating layer 370 serves to protect the roof layer 360.

Although a structure in which the third insulating layer 370 is formed on the roof layer 360 has been described above, the present invention is not limited thereto. That is, for example, the third insulating layer 370 may be omitted.

The overcoat 390 may be formed on the third insulating layer 370. The overcoat 390 may be formed so as to cover the injection hole 307. That is, the overcoat 390 may seal each microcavity 305 so that the liquid crystal molecules 310 formed in the microcavities 305 do not leaked out. Since the overcoat 390 contacts the liquid crystal molecules 310, the overcoat 390 is preferably made of a material that does not react with the liquid crystal molecules 310. For example, the overcoat 390 may be formed of parylene, or the like.

The overcoat 390 may be formed of a multilayer such as a double layer, a triple layer, or the like. The double layer may be formed of two layers made of different materials. The triple layer may be formed of three layers of which adjacent layers are made of different materials. For example, the overcoat 390 may include a layer made of an organic insulating material and a layer made of an inorganic insulating material.

The overcoat 390 may both cover the display area DA and extend beyond it. The overcoat 390 may have a thickness of 10 μm or more. That is, as shown in FIG. 2, the thickness of the overcoat 390 may be thicker than the combined thickness of all structures positioned below the overcoat 390.

Although not shown, a polarizer may be further formed on upper and lower surfaces of the display device. The polarizer may include a first polarizer and a second polarizer. The first polarizer may be attached to a lower surface of the substrate 110, and the second polarizer may be attached to the overcoat 390.

Here, since the second polarizer is attached to the overcoat 390, it is desirable for an upper portion of the overcoat 390 to be flat. In the case in which the upper portion of the overcoat 390 is not flat, the polarizer may not be uniformly attached. Therefore, the polarizer may be subject to lifting.

In the display device according to an exemplary embodiment of the present invention, as shown in FIG. 2, the step compensation part 700 is present at the outer edge of the display area DA of the display device. The step compensation part 700 compensates for a step between the display area DA and a non-display area, to allow the upper portion of the overcoat 390 to be more flatly formed. Therefore, in a subsequent polarizer attaching process, the polarizer may be more uniformly attached and thus less susceptible to lifting. In the case in which the polarizer is not uniformly attached, the area in which the polarizer is lifted may not serve as the display part, such that it is difficult to decrease the bezel. However, as in the present invention, in the case in which the polarizer is entirely uniformly attached to the upper portion of the display device, an area that may serve as the display part may be maximized. Therefore, the bezel may be minimized.

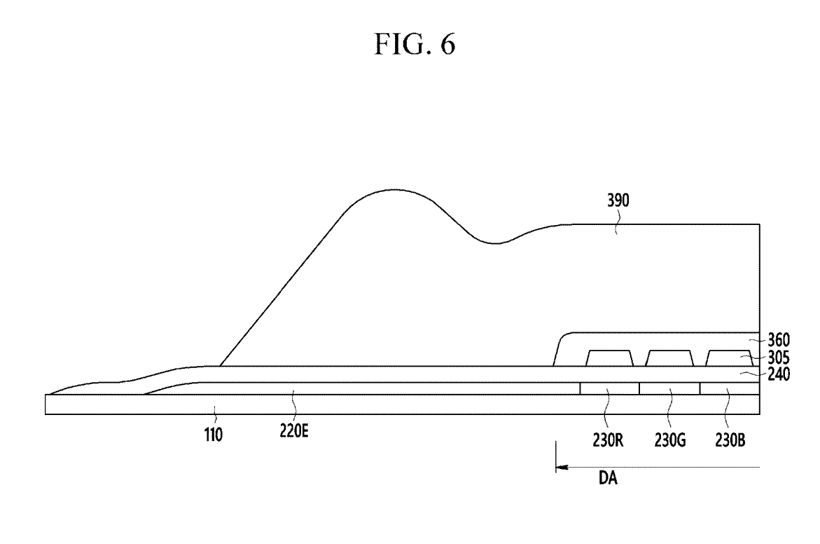

Next, display devices according to various exemplary embodiments of the present invention and effects thereof will be described in detail with reference to a Comparative Example. FIG. 6 is a view showing a cross section of a display device according to a Comparative Example that is substantially the same as a cross section of FIG. 2. Referring to FIG. 6, in the display device according to a Comparative Example, a separate step compensation part is not present outside a display area DA. Therefore, as shown in FIG. 6, an overcoat 390 has a groove formed at an edge thereof, resulting from a step between the display area DA and a non-display area, as well as surface tension of the overcoat 390.

A depth of the groove may be changed depending on a material of the overcoat 390 and process conditions, but may be on the order of tens of micrometers. That is, the depth of the groove may be about 1 to 30 μm.

As a result of the groove formed at the edge of the overcoat 390, the polarizer is not uniformly attached to an upper portion of the overcoat 390.

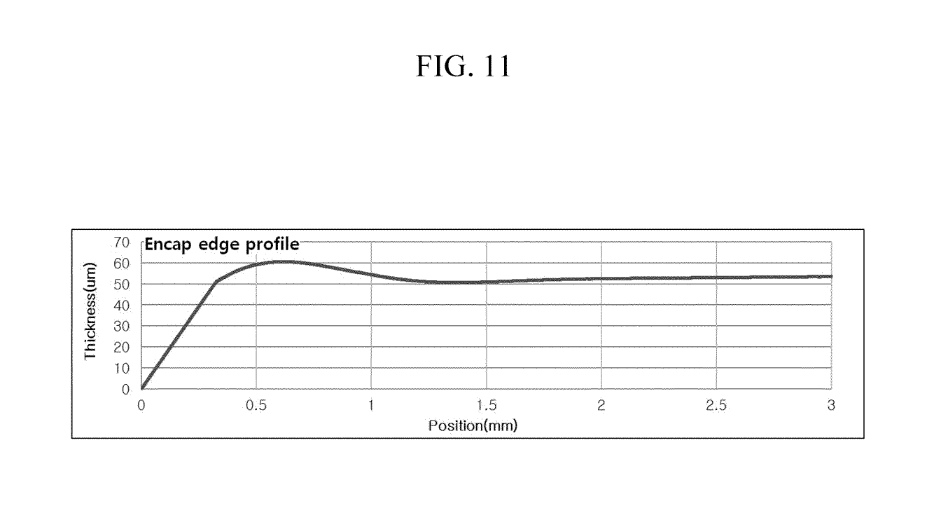

FIG. 11 is a graph showing a thickness of an overcoat in the display device according to the Comparative Example. Referring to FIG. 11, a groove and a thick bump or vertical protrusion appear at the edge of the overcoat. This is due to the surface tension of the overcoat and the step difference in height between the display part and the non-display part underneath the overcoat, as described above.

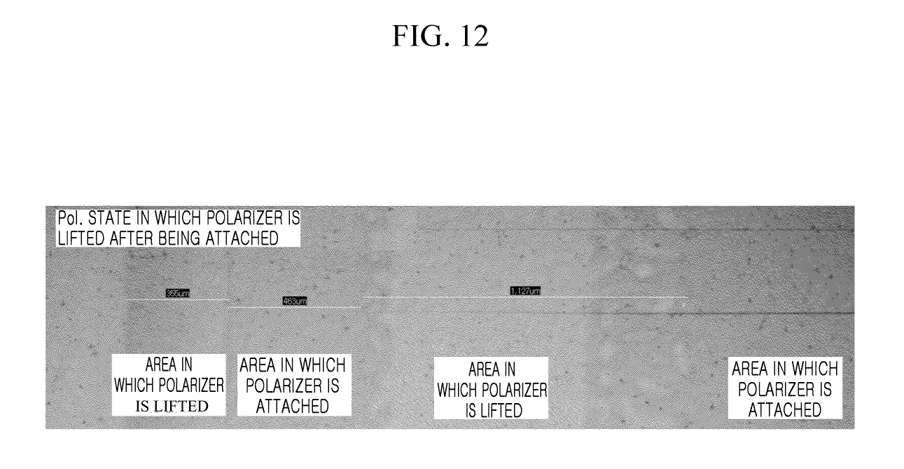

Therefore, in the case in which the polarizer is attached to an overcoat having non-uniform thickness, the polarizer does not closely adhere to the overcoat due to the uneven or non-uniform thickness of the overcoat. FIG. 12 is an image of a polarizer attached to the overcoat in a display device according to the Comparative Example of the present invention.

Referring to FIG. 12, an area in which the polarizer is not attached, but is lifted is brighter than the surrounding areas. That is, as shown in FIG. 12, due to the non-uniform thickness of the overcoat, the polarizer is not entirely attached, but is partially lifted. This portion is subsequently considered as a defect in the display device, and since the area in which the polarizer is lifted at the edge of the overcoat should be covered with a light blocking member or the like to compensate for its added brightness, a width of the bezel is increased. That is, in the case in which the polarizer is lifted at the edge of the overcoat due to the non-uniform thickness of the overcoat, a width of the bezel is kept from being shrunk, due to the need for an added light blocking mechanism at the edge of the display area.

However, in the display device according to an exemplary embodiment of the present invention, the step compensation part is formed at the outer edge of the display area DA to make the upper portion of the overcoat 390 flatter. Therefore, in the case in which the polarizer is attached to the overcoat 390, the polarizer may be more uniformly attached onto the overcoat 390, thus preventing lifting and thereby making it possible to decrease defects in the display device and reduce bezel size.

A position of the step compensation part may be varied depending on, for example, the kind of overcoat used. That is, a position at which the groove is formed may vary by the material of the overcoat, and the position of the step compensation part may be adjusted accordingly.

In addition, a thickness and a width of the step compensation part may also be changed depending on, for example, the kind of overcoat and process conditions. As described below, a depth of the groove may also be changed depending on factors such as the kind of overcoat and process conditions such as a drying condition. Therefore, the thickness and the width of the step compensation part may be appropriately adjusted and implemented by a person of an ordinary skill in the art depending on factors such as the kind of overcoat used in the display device and the drying conditions.

A width of the step compensation part may be generally 0.01 to 5 μm, which is only an example of a numerical value, but is not limited thereto. Likewise, a height of the step compensation part may be about 1 to 30 μm, but is not limited thereto. The step compensation part may include or be made of one or more of the materials used in the display area. A kind of material included in the step compensation part may be changed depending on factors such as a thickness of the step compensation part.

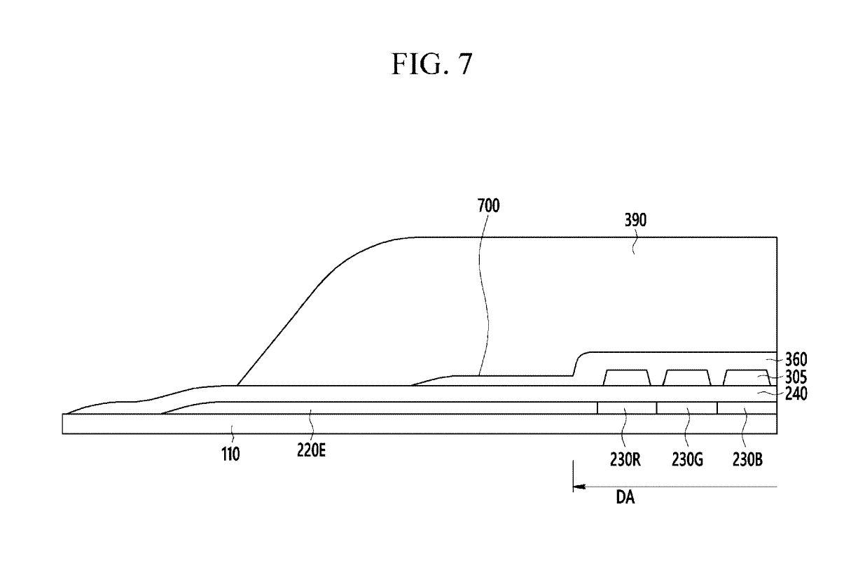

FIGS. 7 to 10 are views showing a step compensation part according to another exemplary embodiment of the present invention.

Referring to FIG. 7, in the display device according to an exemplary embodiment of FIG. 7, the step compensation part includes only the roof layer 360. That is, in the case in which the material of the overcoat 390 does not produce deep grooves, the step may be compensated for only by extending the roof layer 360 into the non-display area, as shown in FIG. 7.

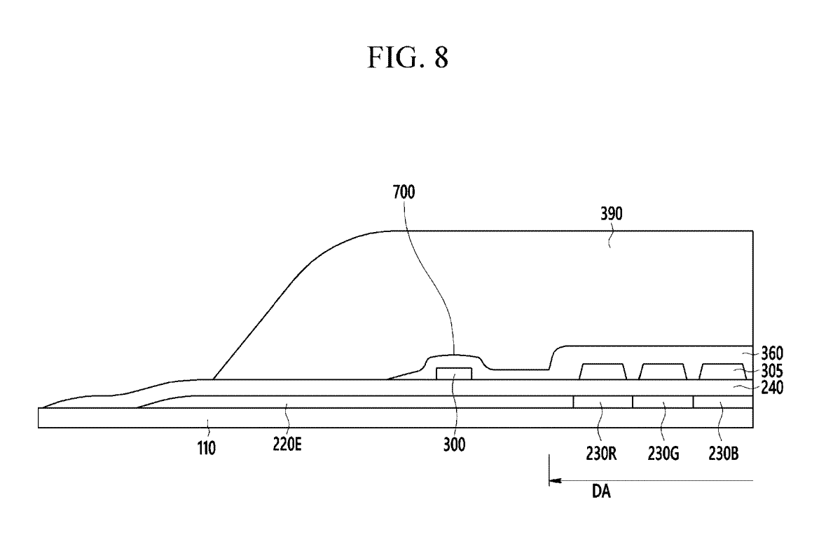

Alternatively, referring to FIG. 8, the step compensation part 700 may include only a material of the roof layer 360 and a material of a sacrifice layer 300. The sacrifice layer 300 is a material stacked in order to form the microcavities 305, and in the display area DA, the sacrifice layer 300 is formed and then removed by a liquid chemical, or the like, thus forming the microcavities 305. However, the sacrifice layer 300 may be kept in the area of the step compensation part, without being removed, and be then protected by the roof layer 360 to form the step compensation part 700.

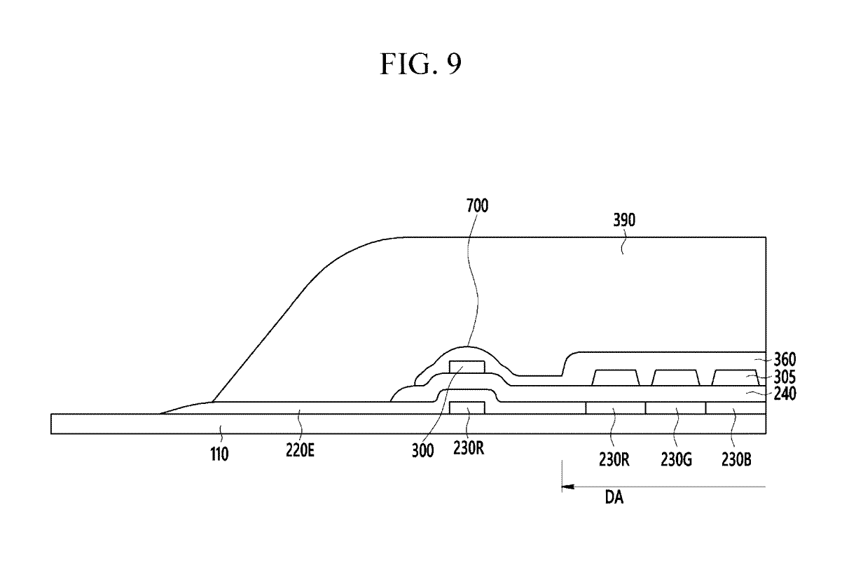

Alternatively, referring to FIG. 9, the step compensation part 700 may be constructed as a stack that includes the color filter 230R, the outer light blocking member 220E, the first insulating layer 240, the sacrifice layer 300, and the roof layer 360. Here, although the case in which the color filter used in step compensation part 700 is the red color filter 230R, one of ordinary skill in the art will observe that a color filter of any color may be used.

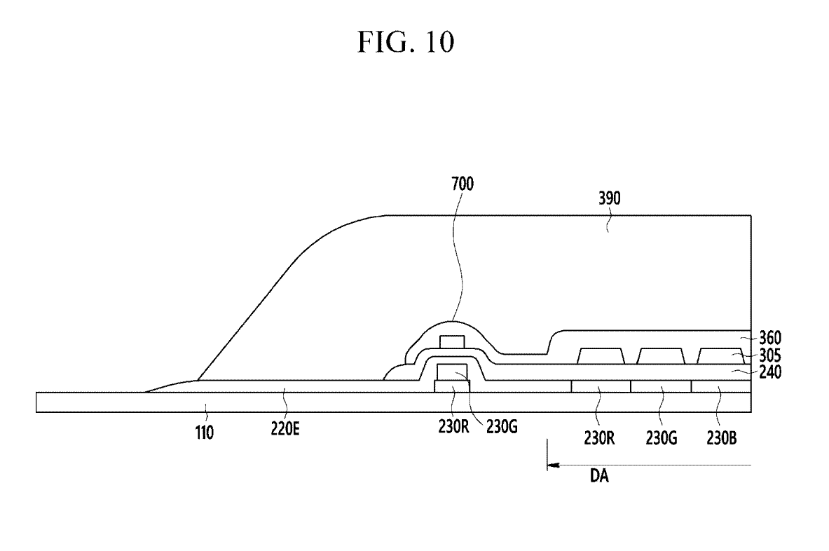

Alternatively, referring to FIG. 10, the step compensation part 700 may include both color filters 230R and 230G, the outer light blocking member 220E, the first insulating layer 240, the sacrifice layer 300, and the roof layer 360. Here, although the double layer of color filters uses red color filter 230R and green color filter 230G, one of ordinary skill in the art will observe that the double layer may include any combination of color filters having any colors.

As described above, in the display device according to an exemplary embodiment of the present invention, the step compensation part 700 includes one or more of the materials configuring the display part DA, and is formed at the outer edge of the display area DA to allow the upper surface of overcoat 390 to be flatter.

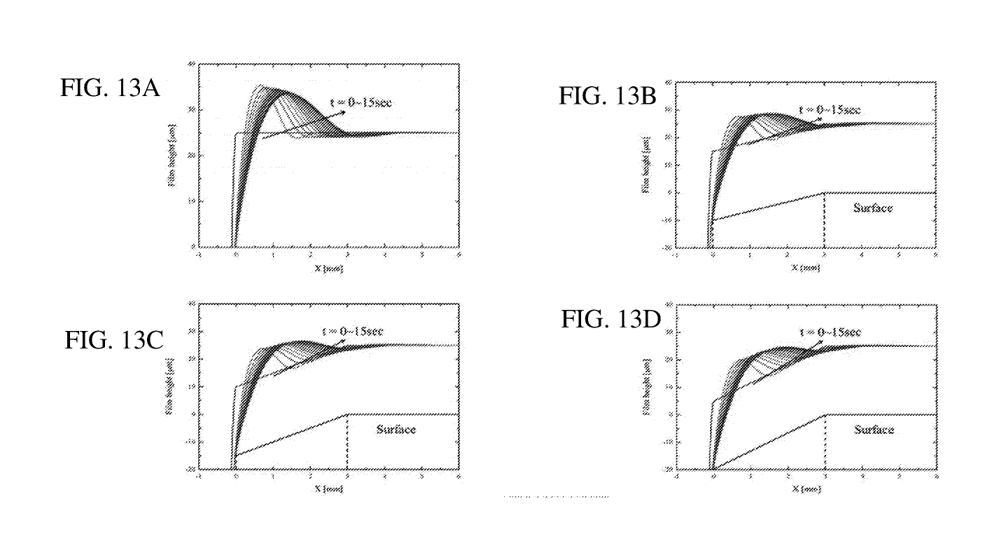

FIGS. 13A to 13D are graphs obtained by simulating an overcoat planarization effect by compensation of a lower step. FIG. 13 corresponds to a Comparative Example in which the step is not compensated for, and FIGS. 13B to 13D correspond to an exemplary embodiment of the present invention in which the step is compensated for.

In the case in which a low portion of the overcoat is flat as in FIG. 13A, a protrusion part is formed at an edge of the overcoat by step difference in height and by surface tension. Although the protrusion part is first formed so as to be high at the edge, the protrusion part slowly spreads inward so as to appear lower and wider over time.

However, in the case in which a more gradually reduced step is used as in FIGS. 13B to 13D, the protrusion part of the overcoat is not formed or is offset by the more gradually reduced height difference even though the protrusion part is formed, thereby configuring substantially a flat surface. That is, it may be confirmed through an experiment result of FIGS. 13A to 13D that flatness of the overcoat may be adjusted by more gradually reducing elevation rather than allowing a step difference in height.

That is, in the present invention, a step compensation part is formed at the outer edge of the display area using some of the materials configuring the display part, in order to compensate for the step difference in height between the display area and the surrounding non-display area of the display device, thereby making it possible to prevent formation of an overcoat that is not flat, which occurs due to the surface tension and the lower step of the overcoat. Therefore, the polarizer may be more uniformly attached to the upper portion of the overcoat without being lifted, thereby making it possible prevent defects in the display device and implement a bezel with a narrower width.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Furthermore, different features of the various embodiments, disclosed or otherwise understood, can be mixed and matched in any manner to produce further embodiments within the scope of the invention.

<Description of symbols>

| | |
|---|---|
| 11: first alignment layer | 21: second alignment layer |

| 110: substrate | |
|---|---|
| 121: gate line | 123: step-down gate line |
| 124h: first gate electrode | 124l: second gate electrode |

| | |
|---|---|
| 124c: third gate electrode | 131: sustain electrode line |

| | |
|---|---|
| 140: gate insulating layer | 154h: first semiconductor |
| 154l: second semiconductor | 154c: third semiconductor |

| | |
|---|---|
| 171: data line | 173h: first source electrode |

| | |
|---|---|
| 173l: second source electrode | 173c: third source electrode |
| 175h: first drain electrode | 175l: second drain electrode |
| 175c: third drain electrode | 180: passivation layer |
| 191: pixel electrode | 191h: first sub-pixel electrode |
| 191l: second sub-pixel electrode | 220: light blocking member |
| 230: color filter | 240: first insulating layer |
| 270: common electrode | 300: sacrifice layer |

| | |
|---|---|
| 305: microcavity | 307: injection hole |

| | |
|---|---|
| 310: liquid crystal molecule | 350: second insulating |

layer

| | |
|---|---|
| 360: roof layer | 370: third insulating layer |
| 390: overcoat | 700: step compensation part |

What is claimed is:

1. A display device comprising:
a display part including a plurality of pixel areas formed on a substrate; and
a non-display part positioned outside and proximate to the display part,
wherein the display part includes:
a pixel electrode formed in at least one of the pixel areas;
a roof layer formed on the pixel electrode so as to be spaced apart from the pixel electrode with a cavity interposed therebetween;
a liquid crystal positioned within the cavity;
an injection hole formed in the roof layer; and
an overcoat formed on the roof layer so as to cover the injection hole and seal the cavity, and
wherein the non-display part includes a step compensation part configured to compensate for a difference in elevation between an upper surface of the display part and an upper surface of the non-display part, the step compensation part including a material of the roof layer.

2. The display device of claim 1, wherein:
the step compensation part further includes one or more materials of the display part.

3. The display device of claim 1, wherein:
the display part has a common electrode formed therein, the common electrode being electrically insulated from the pixel electrode.

4. The display device of claim 1, further comprising:
a color filter stacked below the pixel electrode.

5. The display device of claim 1, wherein:
the roof layer is formed so as to cover the display part and to extend into the non-display part.

6. The display device of claim 1, wherein:
the cavity is formed by applying a sacrifice layer onto the pixel electrode, patterning the sacrifice layer, forming the roof layer on the sacrifice layer, and removing the sacrifice layer.

7. The display device of claim 4, wherein:
the step compensation part includes at least one color filter layer.

8. The display device of claim 6, wherein:
the step compensation part includes material of the sacrifice layer.

9. The display device of claim 4, wherein:
the color filter and the pixel electrode have a first insulating layer formed therebetween.

10. The display device of claim 9, wherein:
the step compensation part includes the first insulating layer.

11. The display device of claim 1, wherein:
the step compensation part has a width of approximately 0.01 to 5 μm.

12. The display device of claim 1, wherein:
the step compensation part has a height of approximately 1 to 30 μm.

13. The display device of claim 1, wherein:
the step compensation part is formed so as to substantially surround four outer edges of the display part.

14. The display device of claim 1, wherein:
the step compensation part is formed so as to be proximate to less than every outer edge of the display part.

15. The display device of claim 1, further comprising:
a polarizer attached to the overcoat.

16. The display device of claim 15, wherein:
the polarizer is substantially entirely attached to an upper portion of the step compensation part.
